(19) United States
(12) Patent Application Publication
(10) Pub. No.: US 2016/0042433 A1
(43) Pub. Date: Feb. 11, 2016

(54) GIFT INFERENCE WITH CONFIRMED SOCIAL MEDIA GIFT ABSENCE

(71) Applicant: International Business Machines Corporation, Armonk, NY (US)

(72) Inventors: Judith H. Bank, Cary, NC (US); Lisa M. Bradley, Cary, NC (US); Lin Sun, Morrisville, NC (US)

(21) Appl. No.: 14/717,693

(22) Filed: May 20, 2015

Related U.S. Application Data
(63) Continuation of application No. 14/453,178, filed on Aug. 6, 2014.

(51) Int. Cl. G06Q 30/06; G06Q 50/00

(52) U.S. Cl. CPC G06Q 30/0631; G06Q 50/01

(57) ABSTRACT

A request is received for a confirmed gift recommendation that is both confirmed as absent from social media content related to a gift recipient and confirmed to have been positively commented on by the gift recipient within a social network. Positive comments about items posted by the gift recipient within the social network are identified. A determination is made that at least one item positively commented on by the gift recipient within the social network is absent from the social media content related to the gift recipient. The request is responded to with the confirmed gift recommendation that includes the determined at least one item positively commented on by the gift recipient within the social network that is also absent from the social media content related to the gift recipient.

### BACKGROUND

The present invention relates to identification of gifts using social media content. More particularly, the present invention relates to gift inference with confirmed social media gift absence.

Social networks allow users to communicate with selected other social network users (e.g., “contacts”) within a hosted network-based environment. Users of a social network may post information to the social network. The posted information may be viewed by the user's contacts within the same social network. The posted information may include stories and photographs.

### BRIEF SUMMARY

A method includes receiving, at a processor, a request for a confirmed gift recommendation that is both confirmed as absent from social media content related to at least one gift recipient and confirmed to have been positively commented on by the at least one gift recipient within a social network; identifying positive comments about items posted by the at least one gift recipient within the social network; determining that at least one item positively commented on by the at least one gift recipient within the social network is absent from the social media content related to the at least one gift recipient; and responding to the request with the confirmed gift recommendation comprising the determined at least one item positively commented on by the at least one gift recipient within the social network that is also absent from the social media content related to the at least one gift recipient.

A system includes a communication module; and a processor programmed to utilize the communication module and to: receive a request for a confirmed gift recommendation that is both confirmed as absent from social media content related to at least one gift recipient and confirmed to have been positively commented on by the at least one gift recipient within a social network; identify positive comments about items posted by the at least one gift recipient within the social network; determine that at least one item positively commented on by the at least one gift recipient within the social network is absent from the social media content related to the at least one gift recipient; and respond to the request with the confirmed gift recommendation comprising the determined at least one item positively commented on by the at least one gift recipient within the social network that is also absent from the social media content related to the at least one gift recipient.

A computer program product includes a computer readable storage medium having computer readable program code embodied therewith, where the computer readable program code when executed on a computer causes the computer to: receive a request for a confirmed gift recommendation that is both confirmed as absent from social media content related to at least one gift recipient and confirmed to have been positively commented on by the at least one gift recipient within a social network; identify positive comments about items posted by the at least one gift recipient within the social network; determine that at least one item positively commented on by the at least one gift recipient within the social network is absent from the social media content related to the at least one gift recipient; and respond to the request with the confirmed gift recommendation comprising the determined at least one item positively commented on by the at least one gift recipient within the social network that is also absent from the social media content related to the at least one gift recipient.

### BRIEF DESCRIPTION OF THE SEVERAL VIEWS OF THE DRAWINGS

FIG. 1 is a block diagram of an example of an implementation of a system for gift inference with confirmed social media gift absence according to an embodiment of the present subject matter;

FIG. 2 is a block diagram of an example of an implementation of a core processing module capable of performing gift inference with confirmed social media gift absence according to an embodiment of the present subject matter;

FIG. 3 is a flow chart of an example of an implementation of a process for gift inference with confirmed social media gift absence according to an embodiment of the present subject matter; and

FIG. 4 is a flow chart of an example of an implementation of a process for gift inference with confirmed social media gift absence that further performs color and style filtering, and complementary gift determinations according to an embodiment of the present subject matter.

### DETAILED DESCRIPTION

The examples set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The subject matter described herein provides gift inference with confirmed social media gift absence. A social network gift giver may specify an individual or a group of individuals within a social network, and may request a gift idea for an individual or group of individuals. The present technology utilizes social media information associated with an individual or with individuals of the group to identify a potential gift item that satisfies two criteria: first, that the potential gift item was positively commented on within the social network by the individual or at least one member of the group; and second, that the potential gift item is absent from the social media information related to items owned by or within the possession of the individual or members of the group. With each of these two criteria satisfied, the present technology makes a gift recommendation of the potential gift to the social network gift giver.

As such, the present technology provides a gift giving correlation between expressed positive comments of potential gifts and the absence of the potential gifts from the possession by a gift recipient within social media content. Accordingly, the present technology provides gift recommendations/suggestions that are reasonably certain to be items that the individual or group of individuals do not already have, and the gift recommendations are also factually based upon expressed positive comments that the individual or group of individuals actually like the potential gift that is recommended.

The present technology may utilize social media information/content, such as photographs, videos, chats, and status updates to identify items that are absent from apparent ownership by the individual or individuals of the group. Use of social communication history and graphical content may be used together to predict the type, style, color, and characteristics of a gift that a specific user or group of users would like to receive. The present technology may determine the actual preferences of a gift recipient, such as favorite colors, styles, and overall tastes of the gift recipient, from photographs or other images of the gift recipient, and from comments made to other social network users within a social network. This tailored information that relates specifically to user tastes may be used to determine whether a suitable potential gift is absent from social media content associated with the gift recipient. With the combined reasonable certainty of a user's tastes with an absence of the potential gift from social media content associated with the gift recipient, an appropriate potential gift item may be identified for the user.

As an example usage scenario, a gift recipient may be identified as a social network user. The gift recipient may be an active social network user that frequently posts pictures about vacations or casual pictures taken with friends. The gift recipient may also post status updates. A picture/video/text data analysis engine may analyze the past communication history within one or more social networks based on the recipient's existing social network context (e.g., pictures, videos, text, new posts, updates, comments to social network posts of others) to determine what the gift recipient may or may not like for gifts. The picture/video/text data analysis engine may further analyze the existing social media content to determine whether the gift ideas are actually absent from the social media content associated with the user.

Further, if the gift giver already has an idea on what to give the gift recipient (e.g., choosing from a few different styles of workout clothing), then the analysis engine may give the gift giver an estimate in the form of a “favorability” score of each of the different styles of workout clothing. The favorability score may help the gift giver to decide which style to choose for the gift recipient.

Alternatively, if the gift giver does not have an idea regarding a category of gift, the system may provide a list of suggested items or categories of items with as much detailed information as possible. For example, a social network user's past posts may be analyzed and a determination made that the user's posts included a status update stating the user acquired a new smartphone and the user also posted a comment regarding a friend's picture stating “I like your smartphone case.” Additional analysis of the user's social media content may result in a determination that the new smartphone is identified in a photograph without a smartphone case. In response to this determination and the affirmative statements regarding the friend's smartphone case, a smartphone case to accessorize the user's new smartphone may be suggested as a gift idea.

With further consideration for the gift recipient's derived preferences with respect to colors and styles, analysis of multiple images of the user or posted by the user may be used to determine that the user likes bold colors (e.g., orange workout shoes may be identified in one photograph and orange colors may be identified in other photographs posted of the recipient's house), and that the user likes contrasts between solids and stripes (e.g., a striped high-tech workout shirt may be seen with solid pants in a photograph). Within this further example, the system may suggest an orange colored smartphone case with stripes to accessorize the orange shoes and striped workout shirt.

The present technology may further access statistical information related to the popularity of colors and styles to further assist with gift recommendations. For example, and in furtherance of the example above, the present technology may search for popular colors or styles and determine that orange is a popular color among many people at the time of the search. As such, the orange color of the smartphone case that may be suggested as the gift recommendation is further statistically reinforced to improve the likelihood that the gift recipient will like the gift and feel fashionable when using the smartphone case.

As such, the gift recipient's preferences with respect to colors and styles may be derived directly from the actual clothes and accessories the gift recipient wears within images posted as content to social media networks. Additionally, statistical analysis of popular colors, styles, trends, and other forms of statistical information may be used to statistically reinforce gift recommendations.

It should be noted that the information derived directly from photographs (e.g., colors, absence of potential gift items from any photographs, etc.) may not likely be available via any other aspect of social media content such as postings or stated preferences/likes. For example, a social media user may not likely list “bold colored clothing” as a like or preference. However, the fact that the gift recipient likes bold colors may be derived and inferred directly from the photographs of the gift recipient and the gift recipient's surroundings (e.g., orange flowers in a picture of the gift recipient's yard, an orange bicycle, orange pillows on a couch, or orange-striped dishes, etc.). This information of actual selection preferences of the gift recipient may be derived with reasonable certainty of accuracy, particularly where a style or color is correlated across multiple photographic images of the gift recipient or the gift recipient's surroundings.

Further, with this information about the gift recipient's preferences with respect to, for example, colors and styles derived directly from the clothes the gift recipient wears, additional analysis of photographs of the user may determine that the user has an older-style gym bag, and it may be determined that the user has made a positive comment about a new-style workout shoulder bag that cinches at the top and that the user (in the same or a separate post) expressed a need for a larger style gym bag than the gym bag currently being used. A gift recommendation of an orange cinch-top shoulder bag may be suggested, again to complement the striped high-tech workout shirt identified in a photograph, the orange workout shoes, and the striped orange smartphone case.

Additionally, where the gift recipient has posted images from a particular smartphone, the smartphone may add annotations such as “posted from my smartphone.” In this situation, the information derived from the posted images may include the model of smartphone, and the gift recommendation may further specify the type of smartphone for which the striped orange smartphone case is recommended.

When a gift giver is interested in receiving a gift suggestion/recommendation for a particular gift recipient, the gift giver may issue a gift suggestion request to a social media gift absence identification module, as described in more detail below. In response to receipt of the gift suggestion request, the social media gift absence identification module creates a new gift search topic, such as within a gift information database, to host information derived during the search of the social media content associated with the gift recipient. The social media gift absence identification module utilizes historical analysis to track social media website postings and blogs by the gift recipient, and performs image analysis of photographs and videos. The social media gift absence identification module identifies the derived gift search criteria as characteristics of potential gifts that are confirmed to be absent from photographs and videos of the gift recipient, and performs an Internet search for items that match the gift search criteria derived from the analysis. The criteria may include matching colors, matching styles, personal accessories or home accessories, items the user has admired or expressed interest in through posts, tickets for events or travel related gifts, items for the family, and other derived gift search criteria as appropriate for a given implementation.

Other examples of derived gift search criteria involve using the analysis of image content (e.g., photographs and videos) to find images of objects that would complement objects identified in the image content. For example if a gift recipient has blue kitchen wallpaper, the present technology may be used to identify kitchen accessories (e.g., place mats, dish towels, potholders, etc.) that complement the color of the kitchen, such as by being blue themselves or by being of complementary colors (e.g., contrasting colors such as orange, etc.), or that complement the style of the kitchen. Similarly, if, based upon analysis of multiple photographs, a gift recipient is determined to be wearing, for example, silver jewelry such as a silver necklace, the present technology may identify silver earrings to match the gift recipient's silver necklace.

Regarding gifts for groups of individuals, a gift idea may be determined based upon analysis of multiple photographs posted by the gift recipient or other social network users that depict the gift recipient hosting family events where multiple adults and multiple children are present. It may be determined from this image analysis that everyone is eating from paper plates that sag in the photos from the weight of the food. One photo may even show a plate of food that is spilled when a child runs in front of an adult that is trying to find a place to sit. The present technology may determine that a gift of sturdy party dinnerware equivalent in serving count to the number of identified adults may be an appropriate gift recommendation. The present technology may further suggest a purchase of a game for the children to play with after the children have eaten so they are occupied while the adults are eating.

It should be noted that the information derived directly from photographs (e.g., a need for more sturdy plates and games to occupy children) would not likely be available via any other aspect of social media content such as postings or stated preferences/likes. However, the fact that the gift recipient(s) need sturdy party plates/dinnerware and games to occupy children may be derived and inferred directly from the photographs.

The present technology may further suggest a “purchase by date” recommendation. For example, where a sale is identified in association with a gift recommendation, or where a gift recipient's birthday is determined from a social network profile, the present technology may utilize these forms of information to recommend purchase dates beyond which a sale may no longer be active or beyond which the gift may not be received by the gift recipient on time for a birthday.

It should be noted that the gift giver and the gift recipient may also be the same individual to allow a gift giver to shop more conveniently and efficiently for items that the gift giver may find useful or enjoyable. For example, for a busy professional or craftsperson, demands of work and family may limit time to research and shop for oneself. Additionally, there may be a significant time difference between a time when a user posts a positive comment about another social network connection's new hobby (e.g., “nice bike”) and a time when the user is seeking to shop for something new and interesting. The present technology spans such a gap by identifying that the user made a positive comment in the past about a hobby that does not appear to be something that the gift giver/recipient participates in within any social media content (e.g., no pictures of the gift giver/recipient on a bicycle). As such, a gift recommendation to buy a new bicycle may be suggested to the gift giver/recipient to purchase a new bicycle. This has an additional benefit that if the gift giver/recipient purchases a new bike and enjoys bike riding, the gift giver/recipient may also then go bike riding with their social network connection that also enjoys bike riding. As such, the technology described herein may be applied to shop for oneself or may be used to shop for gifts for other individuals/groups.

It should be noted that conception of the present subject matter resulted from recognition of certain limitations associated with gift determinations for individuals and groups of individuals. For example, it was observed that it is often difficult to determine what to give certain individuals because some individuals appear to already have “everything.” It was further observed that, while many users enjoy shopping, shopping time is often limited due to other obligations, such as work, school, and family. It was further observed that previous gift identification systems appear to utilize social network profiles of a user and social network “likes” expressed by or a user social network profile of the user to identify gift ideas. However, it was further observed that these social network “likes” and social network profiles do not correlate to any certainty with respect to gift giving because individuals often click a “like” button in a social network user interface in passing without full consideration of whether they would really like to “have” the item, or click the “like” button to promote interests of their social network contacts. It was further observed that individuals usually already have items that may be based upon their stated “likes” and interests within social network profiles (e.g., a user clicks that they “like” golfing and their profile indicates “hobbies: golfing” because they already own three sets of golf clubs and all the golfing accessories they would ever want).

In view of these several observations, it was determined that there was no recognition within previous gift identification systems of trying to make certain that the individual does not already have a potential gift and that they do actually (e.g., factually) like and want to own the actual potential gift. It was further determined from these observations that with limited time to shop, it is desirable to find the “right” desired gift(s) such that the recipient of the gift has a reasonably high likelihood of actually/factually liking “and” wanting the potential gift, which may correlate with a reasonably high likelihood of the recipient not returning a gift. It was additionally determined that social network interest profiles do not result in gift giving ideas that actually/factually correlate with potential gift items that an individual might actually want and need because the information within these prior technologies does not identify absences of potential gifts based upon an individual's social media postings/content. It was further determined that there was no prior system of identifying gifts for groups of individuals using a confirmed absence of a potential gift from social media content associated with the group of individuals in combination with a reasonable certainty of each individual in the group actually/factually appreciating the potential gift. The present subject matter improves gift giving technology by providing for gift inference with confirmed social media gift absence, as described above and in more detail below. As such, improved gift giving and confidence in potential gifts may be obtained through use of the present technology.

The gift inference with confirmed social media gift absence described herein may be performed in real time to allow prompt inference of gift ideas for an individual or group of individuals based upon a confirmed absence of potential gifts from social media content posted by the individual or group of individuals. For purposes of the present description, real time shall include any time frame of sufficiently short duration as to provide reasonable response time for information processing acceptable to a user of the subject matter described. Additionally, the term “real time” shall include what is commonly termed “near real time”—generally meaning any time frame of sufficiently short duration as to provide reasonable response time for on-demand information processing acceptable to a user of the subject matter described (e.g., within a portion of a second or within a few seconds). These terms, while difficult to precisely define are well understood by those skilled in the art.

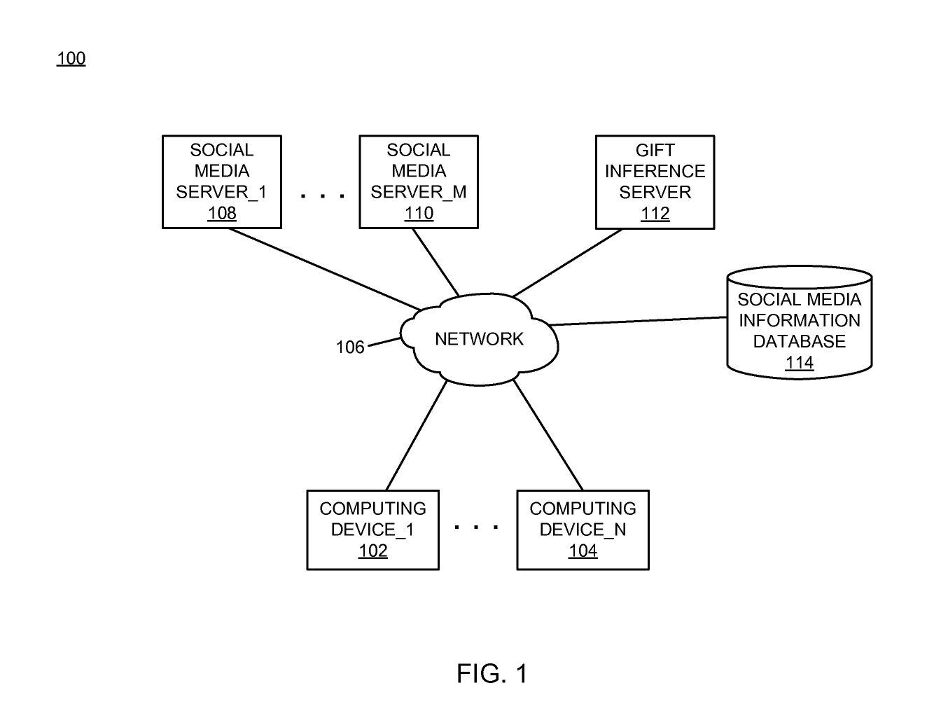

FIG. 1 is a block diagram of an example of an implementation of a system 100 for gift inference with confirmed social media gift absence. A computing device_1 102 through a computing device_N 104 communicate via a network 106 with several other devices. The other devices include a social media server_1 108 through a social media server_M 110. The social media server_1 108 through the social media server_M 110 represent server devices that host one or more social networks for communications and information sharing among social network users.

A gift inference server 112 is also illustrated, and may also be implemented as one or more server devices. The gift inference server 112 performs analysis of social media content posted by social network users within the social networks hosted by the social media server_1 108 through the social media server_M 110 and responds to inquiries/requests for gift suggestions/recommendations by inferring gift suggestions based upon confirmed gift absence from analyzed social media content. It should be noted that the gift inference server 112 may be additionally and/or alternatively implemented in association with one or more of the social media server_1 108 through the social media server_M 110, or may be implemented in association with one or more of the computing device_1 102 through the computing device_N 104, as appropriate for a given implementation. A social media information database 114 provides social media content storage for analysis and inference of gifts for social network users, as described herein.

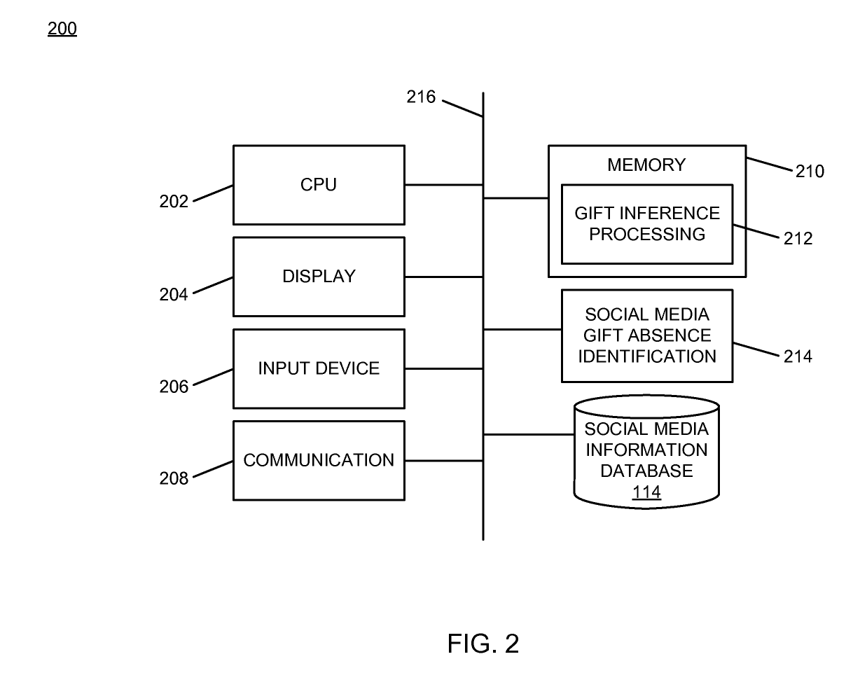

As will be described in more detail below in association with FIG. 2 through FIG. 4, the gift inference server 112, whether implemented as a stand-alone device or as part of one or more of the respective computing device_1 102 through the computing device_N 104 and/or the social media server_1 108 through the social media server_M 110, may provide automated gift inference with confirmed social media gift absence. As such, the present technology may be implemented at a user computing device or server device level. The automated gift inference with confirmed social media gift absence is based upon correlation of expressed interests in items, inference of favorite colors/styles, etc. from image content, and a confirmed absence of the potential gift idea(s) from social media content. A variety of possibilities exist for implementation of the present subject matter, and all such possibilities are considered within the scope of the present subject matter.

It should be noted that any of the respective computing devices described in association with FIG. 1 may be portable computing devices, either by a user's ability to move the respective computing devices to different locations, or by the respective computing device's association with a portable platform, such as a plane, train, automobile, or other moving vehicle. It should also be noted that the respective computing devices may be any computing devices capable of processing information as described above and in more detail below. For example, the respective computing devices may include devices such as a personal computer (e.g., desktop, laptop, etc.) or a handheld device (e.g., cellular telephone, personal digital assistant (PDA), email device, tablet computing device, e-book reading device, etc.), a web server, an application server, or other data server device, or any other device capable of processing information as described above and in more detail below.

The network 106 may include any form of interconnection suitable for the intended purpose, including a private or public network such as an intranet or the Internet, respectively, direct inter-module interconnection, dial-up, wireless, or any other interconnection mechanism capable of interconnecting the respective devices. The social media information database 114 may include a relational database, an object database, or any other storage type of device. As such, the social media information database 114 may be implemented as appropriate for a given implementation.

It should be noted that though the gift inference server 112 is illustrated as a separate component in FIG. 1, this should not be considered limiting because the functionality of the gift inference server 112 may be implemented in any of the other devices illustrated within FIG. 1 or may be a distributed component with portions of functionality operationally distributed across multiple components or multiple devices.

FIG. 2 is a block diagram of an example of an implementation of a core processing module 200 capable of performing gift inference with confirmed social media gift absence. The core processing module 200 implements the functionality of the gift inference server 112 and also illustrates a computing architecture that may be associated with and/or distributed among one or more of the gift inference server 112, the computing device_1 102 through the computing device_N 104, and/or with the server_1 108 through the server_M 110, as appropriate for a given implementation. As such, the core processing module 200 is described generally herein, though it is understood that many variations on implementation of the components within the core processing module 200 are possible and all such variations are within the scope of the present subject matter.

Further, the core processing module 200 may provide different and complementary processing of gift inference with confirmed social media gift absence in association with each implementation. As such, for any of the examples below, it is understood that any aspect of functionality described with respect to any one device that is described in conjunction with another device (e.g., sends/sending, etc.) is to be understood to concurrently describe the functionality of the other respective device (e.g., receives/receiving, etc.).

A central processing unit (CPU) 202 (“processor”) provides hardware that performs computer instruction execution, computation, and other capabilities within the core processing module 200. A display 204 provides visual information to a user of the core processing module 200 and an input device 206 provides input capabilities for the user.

The display 204 may include any display device, such as a cathode ray tube (CRT), liquid crystal display (LCD), light emitting diode (LED), electronic ink displays, projection, touchscreen, or other display element or panel. The input device 206 may include a computer keyboard, a keypad, a mouse, a pen, a joystick, touchscreen, voice command processing unit, or any other type of input device by which the user may interact with and respond to information on the display 204.

It should be noted that the display 204 and the input device 206 may be optional components for the core processing module 200 for certain implementations/devices, or may be located remotely from the respective devices and hosted by another computing device that is in communication with the respective devices. Accordingly, the core processing module 200 may operate as a completely automated embedded device without direct user configurability or feedback. However, the core processing module 200 may also provide user feedback and configurability via the display 204 and the input device 206, respectively, as appropriate for a given implementation.

A communication module 208 provides hardware, protocol stack processing, and interconnection capabilities that allow the core processing module 200 to communicate with other modules within the system 100. The communication module 208 may include any electrical, protocol, and protocol conversion capabilities useable to provide interconnection capabilities, appropriate for a given implementation.

A memory 210 includes a gift inference processing area 212 that stores information derived from social media content and inferences of potential gift ideas as described herein in association with the core processing module 200. As will be described in more detail below, the information stored within the gift inference processing area 212 is used to provide gift suggestions that are determined to be relevant to expressed interests of intended gift recipients, to match or complement confirmed color and style preferences of the intended gift recipients, and that are confirmed to be absent from social media content associated with the intended gift recipient (e.g., not shown to be already owned by the intended gift recipient).

It is understood that the memory 210 may include any combination of volatile and non-volatile memory suitable for the intended purpose, distributed or localized as appropriate, and may include other memory segments not illustrated within the present example for ease of illustration purposes. For example, the memory 210 may include a code storage area, an operating system storage area, a code execution area, and a data area without departure from the scope of the present subject matter.

A social media gift absence identification module 214 is also illustrated. The social media gift absence identification module 214 utilizes historical analysis of posted social media content and provides inferred gift suggestions that are not found within the analyzed posted social media content for the core processing module 200, as described above and in more detail below. The social media gift absence identification module 214 implements the automated gift inference with confirmed social media gift absence of the core processing module 200, and may be implemented in association with any device that implements all or a portion of the automated gift inference with confirmed social media gift absence. It is understood that the social media gift absence identification module 214 may include a historical analysis component, a picture/video/text analysis component, and a graphical analysis component that may be used to derive inferences of preferred colors and styles of potential gifts and gift recommendations that are absent from social media content postings associated with gift recipients.

It should also be noted that the social media gift absence identification module 214 may form a portion of other circuitry described without departure from the scope of the present subject matter. Further, the social media gift absence identification module 214 may alternatively be implemented as an application stored within the memory 210. In such an implementation, the social media gift absence identification module 214 may include instructions executed by the CPU 202 for performing the functionality described herein. The CPU 202 may execute these instructions to provide the processing capabilities described above and in more detail below for the core processing module 200. The social media gift absence identification module 214 may form a portion of an interrupt service routine (ISR), a portion of an operating system, a portion of a browser application, or a portion of a separate application without departure from the scope of the present subject matter.

The social media information database 114 is again shown within FIG. 2 associated with the core processing module 200. As such, the social media information database 114 may be operatively coupled to the core processing module 200 without use of network connectivity, as appropriate for a given implementation.

The CPU 202, the display 204, the input device 206, the communication module 208, the memory 210, the social media gift absence identification module 214, and the social media information database 114 are interconnected via an interconnection 216. The interconnection 216 may include a system bus, a network, or any other interconnection capable of providing the respective components with suitable interconnection for the respective purpose.

Though the different modules illustrated within FIG. 2 are illustrated as component-level modules for ease of illustration and description purposes, it should be noted that these modules may include any hardware, programmed processor(s), and memory used to carry out the functions of the respective modules as described above and in more detail below. For example, the modules may include additional controller circuitry in the form of application specific integrated circuits (ASICs), processors, antennas, and/or discrete integrated circuits and components for performing communication and electrical control activities associated with the respective modules. Additionally, the modules may include interrupt-level, stack-level, and application-level modules as appropriate. Furthermore, the modules may include any memory components used for storage, execution, and data processing for performing processing activities associated with the respective modules. The modules may also form a portion of other circuitry described or may be combined without departure from the scope of the present subject matter.

Additionally, while the core processing module 200 is illustrated with and has certain components described, other modules and components may be associated with the core processing module 200 without departure from the scope of the present subject matter. Additionally, it should be noted that, while the core processing module 200 is described as a single device for ease of illustration purposes, the components within the core processing module 200 may be co-located or distributed and interconnected via a network without departure from the scope of the present subject matter. For a distributed arrangement, the display 204 and the input device 206 may be located at a point of sale device, kiosk, or other location, while the CPU 202 and memory 210 may be located at a local or remote server. Many other possible arrangements for components of the core processing module 200 are possible and all are considered within the scope of the present subject matter. It should also be understood that, though the social media information database 114 is illustrated as a separate component for purposes of example, the information stored within the social media information database 114 may also/alternatively be stored within the memory 210 without departure from the scope of the present subject matter. Accordingly, the core processing module 200 may take many forms and may be associated with many platforms.

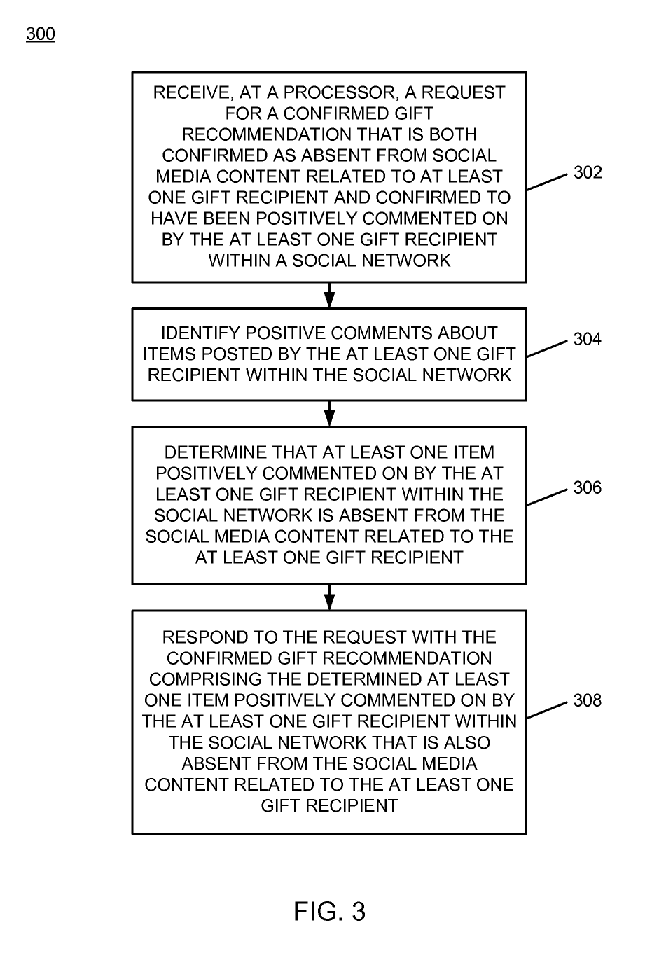

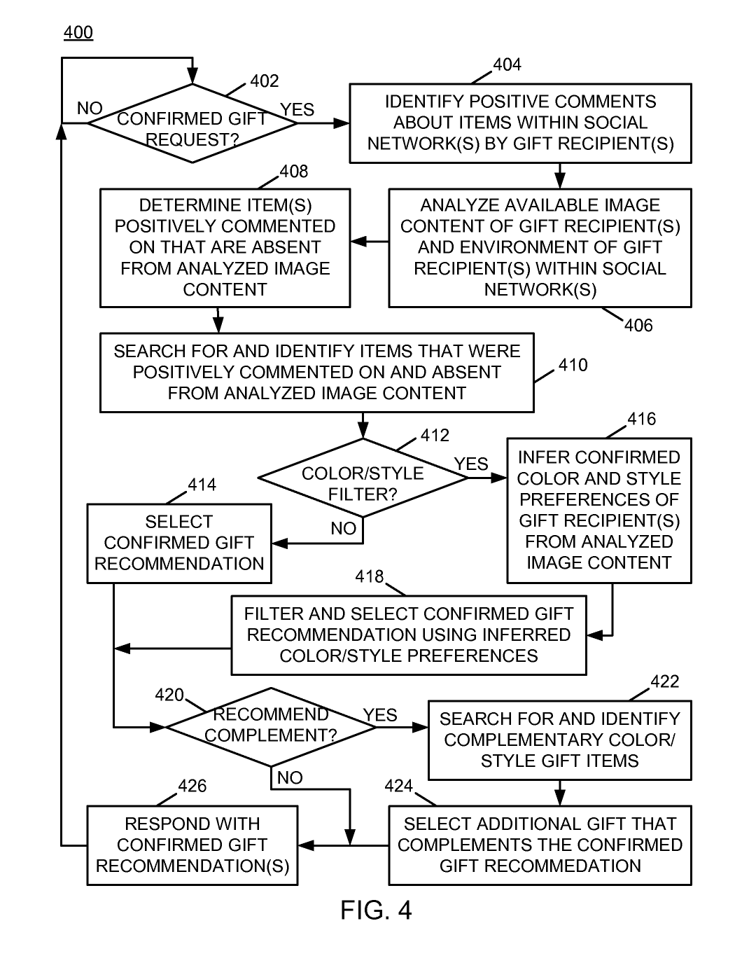

FIG. 3 through FIG. 4 described below represent example processes that may be executed by devices, such as the core processing module 200, to perform the automated gift inference with confirmed social media gift absence associated with the present subject matter. Many other variations on the example processes are possible and all are considered within the scope of the present subject matter. The example processes may be performed by modules, such as the social media gift absence identification module 214 and/or executed by the CPU 202, associated with such devices. It should be noted that time out procedures and other error control procedures are not illustrated within the example processes described below for ease of illustration purposes. However, it is understood that all such procedures are considered to be within the scope of the present subject matter. Further, the described processes may be combined, sequences of the processing described may be changed, and additional processing may be added or removed without departure from the scope of the present subject matter.

FIG. 3 is a flow chart of an example of an implementation of a process 300 for gift inference with confirmed social media gift absence. At block 302, the process 300 receives, at a processor, a request for a confirmed gift recommendation that is both confirmed as absent from social media content related to at least one gift recipient and confirmed to have been positively commented on by the at least one gift recipient within a social network. At block 304, the process 300 identifies positive comments about items posted by the at least one gift recipient within the social network. At block 306, the process 300 determines that at least one item positively commented on by the at least one gift recipient within the social network is absent from the social media content related to the at least one gift recipient. At block 308, the process 300 responds to the request with the confirmed gift recommendation comprising the determined at least one item positively commented on by the at least one gift recipient within the social network that is also absent from the social media content related to the at least one gift recipient.

FIG. 4 is a flow chart of an example of an implementation of a process 400 for gift inference with confirmed social media gift absence that further performs color and style filtering, and complementary gift determinations. At decision point 402, the process 400 makes a determination as to whether a request for a confirmed gift recommendation that is both confirmed as absent from social media content related to a gift recipient and confirmed to have been positively commented on within a social network has been detected.

It should be noted that the gift recipient may include a group of individuals, and that one or more individuals of the group of individuals may be a member of one or more social networks and may post comments and/or images of the group to the respective social networks. As such, not all individuals of the group have to be members of or participate in social networks for a gift giver to utilize the present technology to identify gifts for the group.

Additionally, the social media content related to respective gift recipient(s) may include posted image content that includes the gift recipient or an environment associated with the gift recipient. Similarly, the gift recommendation for which the respective gift recipient(s) has positively commented may be any form of a social network posting where the respective gift recipient(s) may have complimented another social network user (e.g., “nice bike”).

Further, the initial request for the confirmed gift recommendation may also include a request for one or more complementary gifts. Complementary gifts may include accessories (e.g., a smartphone case that matches a gift recipient's favorite color or style), or may include any other additional gift that stylistically or color-wise matches the primary requested confirmed gift recommendation.

In response to determining at decision point 402 that a request for a confirmed gift recommendation that is both confirmed as absent from social media content related to at least one gift recipient and confirmed to have been positively commented on within a social network has been detected, the process 400 identifies positive comments about items posted by the respective gift recipient(s) within one or more social networks at block 404. It should be noted that the identified positive comments may be positive comments posted by one or more individuals of a group of individuals where the gift recipient is a group of individuals.

At block 406, the process 400 analyzes available image content posted within the social network(s), including available image content of the respective gift recipient(s) and image content of environments associated with the gift recipient(s). At block 408, the process 400 determines from the analyzed image content one or more items that were positively commented on by the respective gift recipient(s) that are absent from the analyzed image content (e.g., a positive comment was made about another social network user's smartphone case, but there is no image of the gift recipient(s) with a smartphone case on their smartphone). As also described above, the gift recipient may be a group of individuals. As such, the process 400 may determine an item positively commented on by at least one individual of the group of individuals that is also absent from analyzed images of the group of individuals (e.g., the group enjoys camping, but have no camping seats within any photographs). At block 410, the process 400 searches for and identifies items that are available for purchase that were both positively commented on and are determined to be absent from the analyzed image content. The search and identification of items that are available for purchase that are both positively commented on and are determined to be absent from the analyzed image content may include one or more Internet searches or specific retail website searches, as appropriate for a given implementation.

At decision point 412, the process 400 makes a determination as to whether to perform color and/or style filtering on items identified by the search. In response to determining at decision point 412 not to perform color and/or style filtering on items identified by the search, the process 400 selects a confirmed gift recommendation for the gift recipient(s) from the identified items that are available for purchase that are both positively commented on and are determined to be absent from the analyzed image content at block 414.

In response to determining at decision point 412 to perform color and/or style filtering on items identified by the search, the process 400 infers at least one of a color preference and a style preference of the respective gift recipient(s) using image analysis of image content related to the gift recipient(s) posted within the social network at block 416. The color and style preferences may be inferred, for example, by identification of dominant colors or styles of clothes worn by the gift recipient(s), or colors and styles of furnishings, vehicles, or other accessories shown in association with the gift recipient(s) within image content posted within one or more social networks. At block 418, using the inferred color preference(s) and style preference(s) of the gift recipient(s), the process 400 filters and selects available items that have been both positively commented on by the gift recipient(s) within the social network and that are also absent from the social media content related to the gift recipient(s).

In response to either selecting the confirmed gift recommendation for the gift recipient(s) from the identified items that are available for purchase that were both positively commented on and also determined to be absent from the analyzed image content at block 414, or in response to filtering and selecting available items, using the inferred color preference(s) and style preference(s) of the gift recipient(s), that were both positively commented on by the gift recipient(s) within the social network and that are also absent from the social media content related to the gift recipient(s) at block 418, the process 400 makes a determination at decision point 420 as to whether to recommend a complementary gift for the gift recipient(s). The determination as to whether to recommend a complementary gift for the gift recipient(s) may be performed based upon an initial request that the confirmed gift recommendation also include a request for one or more complementary gifts, or may be part of a configuration setting for the process 400.

In response to determining at decision point 420 to recommend a complementary gift for the gift recipient(s), the process 400 searches for and identifies complementary gifts/items that are available for purchase at block 422. As with the search described above, the search and identification of complementary gifts that are available for purchase may include one or more Internet searches or specific retail website searches, as appropriate for a given implementation. At block 424, the process 400 selects an additional gift that complements the confirmed gift recommendation as an additional complementary gift suggestion.

In response to either selecting the additional gift that complements the confirmed gift recommendation as the additional complementary gift suggestion at block 424, or in response to determining at decision point 420 not to recommend a complementary gift for the gift recipient(s), the process 400 responds to the request for a confirmed gift recommendation with the confirmed gift recommendation and any additional complementary gift suggestions at block 426. As described above, the confirmed gift recommendation is a gift suggestion that represents at least one item that has been positively commented on by the gift recipient (or at least one gift recipient of a group of gift recipients) within the social network and that is also absent from the social media content related to the respective gift recipient(s). The process 400 returns to decision point 402 and iterates as described above.

As such, the process 400 responds to requests for gift recommendations that are requested to be confirmed items that were both positively commented on and not shown to be owned by the gift recipient(s) by being absent from any social network image content associated with the gift recipient(s). The process 400 identifies and analyzes posted comments and image content to identify items that were both positively commented on and not shown to be owned by the gift recipient(s) by being absent from any social network image content associated with the gift recipient(s). The process searches for and identifies the requested confirmed gift recommendation, and may further infer color and style preferences of the primary confirmed gift recommendation and complementary gifts to accompany the primary confirmed gift recommendation.

As described above in association with FIG. 1 through FIG. 4, the example systems and processes provide gift inference with confirmed social media gift absence. Many other variations and additional activities associated with gift inference with confirmed social media gift absence are possible and all are considered within the scope of the present subject matter.

Those skilled in the art will recognize, upon consideration of the above teachings, that certain of the above examples are based upon use of a programmed processor, such as the CPU 202. However, the invention is not limited to such example embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art based upon the teachings herein without departing from the scope and spirit of the invention. The subject matter was described to explain the principles of the invention and the practical application, and to enable others of ordinary skill in the art to understand the invention for various embodiments with various modifications as are suited to the particular use contemplated.

What is claimed is:

1. A method, comprising:
receiving, at a processor, a request for a confirmed gift recommendation that is both confirmed as absent from social media content related to at least one gift recipient and confirmed to have been positively commented on by the at least one gift recipient within a social network;
identifying positive comments about items posted by the at least one gift recipient within the social network;
determining that at least one item positively commented on by the at least one gift recipient within the social network is absent from the social media content related to the at least one gift recipient; and
responding to the request with the confirmed gift recommendation comprising the determined at least one item positively commented on by the at least one gift recipient within the social network that is also absent from the social media content related to the at least one gift recipient.

2. The method of claim 1, where the social media content related to the at least one gift recipient comprises posted image content that includes one of the at least one gift recipient and an environment associated with the at least one gift recipient.

3. The method of claim 1, where the at least one gift recipient comprises a group of individuals for which at least one individual of the group of individuals posted an image of the group of individuals within the social network and positively commented on the at least one item.

4. The method of claim 3, where determining that the at least one item positively commented on by the at least one gift recipient within the social network is absent from the social media content related to the at least one gift recipient comprises:
analyzing the image of the group of individuals posted within the social network; and
determining that the at least one item positively commented on by the at least one individual of the group of individuals is absent from the analyzed image of the group of individuals.

5. The method of claim 1, further comprising inferring at least one of a color preference and a style preference of the at least one gift recipient using image analysis of image content related to the at least one gift recipient posted within the social network.

6. The method of claim 5, further comprising:
filtering, using the inferred at least one of the color preference and the style preference of the at least one gift recipient, available items that are both positively commented on by the at least one gift recipient within the social network and absent from the social media content related to the at least one gift recipient; and
where responding to the request with the confirmed gift recommendation comprising the at least one item positively commented on by the at least one gift recipient within the social network that is also absent from the social media content related to the at least one gift recipient comprises:
responding to the request with the confirmed gift recommendation comprising a filtered gift recommendation that matches the inferred at least one of the color preference and the style preference of the at least one gift recipient that is both positively commented on by the at least one gift recipient within the social network and absent from the social media content related to the at least one gift recipient.

7. The method of claim 5, further comprising suggesting an additional complementary gift that complements the confirmed gift recommendation with respect to the at least one of the color preference and the style preference of the at least one gift recipient that is also absent from the social media content related to the at least one gift recipient.
